(19) United States
(12) Patent Application Publication
(10) Pub. No.: US 2020/0378563 A1
(43) Pub. Date: Dec. 3, 2020

(54) LIGHT BULB

(71) Applicant: XIAMEN ECO LIGHTING CO. LTD., Xiamen (CN)

(72) Inventors: Yanzeng Gao, Xiamen (CN); Xu Wu, Xiamen (CN); Juncheng Che, Xiamen (CN)

(21) Appl. No.: 16/852,474

(22) Filed: Apr. 18, 2020

(30) Foreign Application Priority Data
May 31, 2019 (CN) 201920810533.4

(51) Int. Cl. F21K 9/232; F21K 9/69; F21V 5/00; F21V 29/80; F21S 10/04

(52) U.S. Cl. CPC F21K 9/232; F21K 9/69; F21Y 2115/10; F21V 29/80; F21S 10/04; F21V 5/007

(57) ABSTRACT

The filament bulb includes a bulb head, a bulb and multiple light source components. The bulb is disposed on the bulb head. The light source components are used for luminescence. The light source components are connected to the bulb head. The light source components are extended the bulb. The light source components include a central column, a bracket, and multiple LED light filaments. The central column is disposed on the bulb head. The bracket is disposed on the central column. The supporting wire is fixed on the central column. A circumferential direction of the central column is surrounded by multiple LED light filaments.

### FIELD

The present application is related to a light bulb and more particularly related to a LED light bulb with wide angle illumination.

### BACKGROUND

Electroluminescence, an optical and electrical phenomenon, was discover in 1907. Electroluminescence refers the process when a material emits light when a passage of an electric field or current occurs. LED stands for light-emitting diode. The very first LED was reported being created in 1927by a Russian inventor. During decades' development, the first practical LED was found in 1961, and was issued patent by the U.S. patent office in 1962. In the second half of 1962, the first commercial LED product emitting low-intensity infrared light was introduced. The first visible-spectrum LED, which limited to red, was then developed in 1962.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

With high light output, LEDs are available across the visible, infrared wavelengths, and ultraviolet lighting fixtures. Recently, there is a high-output white light LED. And this kind of high-output white light LEDs are suitable for room and outdoor area lighting. Having led to new displays and sensors, LEDs are now be used in advertising, traffic signals, medical devices, camera flashes, lighted wallpaper, aviation lighting, horticultural grow lights, and automotive headlamps. Also, they are used in cellphones to show messages.

A Fluorescent lamp refers to a gas-discharge lamps. The invention of fluorescent lamps, which are also called fluorescent tubes, can be traced back to hundreds of years ago. Being invented by Thomas Edison in 1896, fluorescent lamps used calcium tungstate as the substance to fluoresce then. In 1939, they were firstly introduced to the market as commercial products with variety of types.

In a fluorescent lamp tube, there is a mix of mercury vapor, xenon, argon, and neon, or krypton. A fluorescent coating coats on the inner wall of the lamp. The fluorescent coating is made of blends of rare-earth phosphor and metallic salts. Normally, the electrodes of the lamp comprise coiled tungsten. The electrodes are also coated with strontium, calcium oxides and barium. An internal opaque reflector can be found in some fluorescent lamps. Normally, the shape of the light tubes is straight. Sometimes, the light tubes are made circle for special usages. Also, u-shaped tubes are seen to provide light for more compact areas.

Because there is mercury in fluorescent lamps, it is likely that the mercury contaminates the environment after the lamps are broken. Electromagnetic ballasts in fluorescent lamps are capable of producing buzzing mouse. Radio frequency interference is likely to be made by old fluorescent lamps. The operation of fluorescent lamps requires specific temperature, which is best around room temperature. If the lamps are placed in places with too low or high temperature, the efficacy of the lamps decreases.

In real lighting device design, details are critical no matter how small they appear. For example, to fix two components together conveniently usually brings large technical effect in the field of light device particularly when any such design involves a very large number of products to be sold around the world.

### SUMMARY

In some embodiments, A light bulb includes multiple LED filaments, a bulb shell, a bulb head, a central column, a bracket and multiple supporting wires.

Each LED filament has a first top electrode and a bottom electrode. The bulb head defines a container space with the bulb shell for enclosing the multiple LED filaments.

The central column includes a support and a column part. The bracket is fixed to a top end of the column part and extending outwardly. A bottom end of the column part is fixed to the support. The top ends of the multiple LED filaments are fixed to the bracket to keep a tilt angle with respect to a longitudinal direction of the central column.

The multiple supporting wires are respectively connected the bottom ends of the multiple LED filaments to the support of the central column.

In some embodiments, there is a first closet point of the LED filament with a closest distance from the LED filament to a second closest point of the central column, a first line defined by the first closest point and the second closest point and the longitudinal direction of the central column form a first plane, the tilt angle measured between a longitudinal direction of the LED filament and the first plane.

In some embodiments, the tilt angle is between 10 degrees to 60 degrees. In some embodiments, the closest point of the LED filament is closer to the bottom electrode of the LED filament than to the top electrode of the LED filament.

In some embodiments, the bracket has multiple extending wires respectively for connecting to the top ends of the multiple LED filaments.

In some embodiments, the bracket has a support ring, the extending wires are extended from the support ring.

In some embodiments, there is a structure enhancing piece inside the support ring to enhance structural strengthens of the support ring.

In some embodiments, there are a first set of LED chips and a second set of LED chips, the first set of LED chips emitting light outwardly with respect to the light bulb and the second set of LED chips emitting light toward dark sections of an adjacent LED filament.

In some embodiments, the light bulb may also include a driver for controlling a luminance level ratio between the first set of LED chips and the second set of LED chips to keep an even overall light pattern of the light bulb.

In some embodiments, there are multiple lens arranged on the bulb shell.

In some embodiments, the multiple lens has prism effect for diving a white light to multiple color beams.

In some embodiments, the bracket is made of metal material.

In some embodiments, the column part includes two vertical levers.

In some embodiments, the support of the central column is made of glass and has a sealed gas hole for installing heat dissipation gas into the container space.

In some embodiments, the heat dissipation gas in the container space contains oxygen more than 1% ratio of all heat dissipation gas.

In some embodiments, the multiple supporting wires are respectively connected to different isolated heat sinks.

In some embodiments, there are a first set of LED chips and a second set of LED Chips on the LED filament, the first set of LED chips are mounted closer to the top electrode of the LED filament and the second set of LED chips are mounted closer to the bottom electrode of the LED filament, the first set of LED chips emit lights with lower color temperature than the second set of LED chips.

In some embodiments, the light bulb may also include a driver for controlling luminance levels of the multiple LED filaments to vary separately with a predetermined pattern along a time period to simulate a flame effect.

In some embodiments, a color temperature of the LED filament also varies when simulating the flame effect.

In some embodiments, the supporting wires and the bracket are deformed when installing into the bulb shell and recovers shapes after being placed into the bulb shell.

### BRIEF DESCRIPTION OF DRAWINGS

FIG. 1 illustrates a light bulb embodiment.

FIG. 2 illustrates a view of an example.

FIG. 3 illustrates another view of the example in FIG. 2.

FIG. 4 illustrates a first example of a support ring.

FIG. 5 illustrates a second example of a support ring.

FIG. 6 illustrates a structure concept for an embodiment.

FIG. 7A and FIG. 7B show a component relation.

FIG. 8 shows a LED filament example.

FIG. 9 shows another LED filament example.

### DETAILED DESCRIPTION

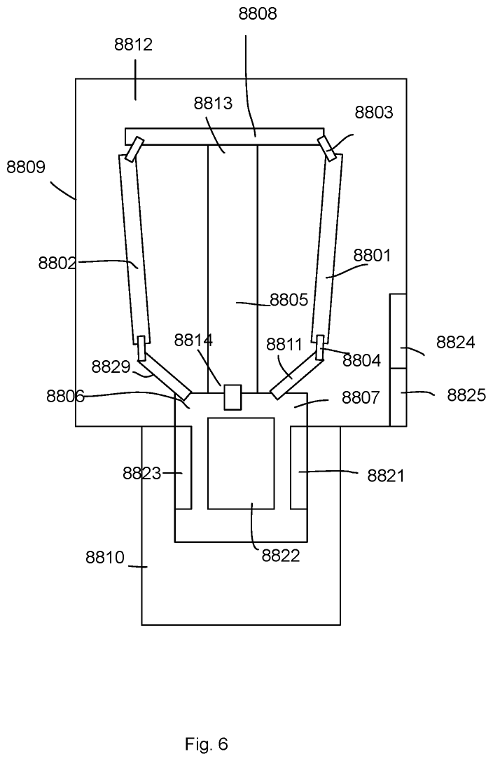

In FIG. 6, a light bulb includes multiple LED filaments 8801, 8802, a bulb shell 8809, a bulb head 8810, a central column 8807, a bracket 8808 and multiple supporting wires 8811.

Each LED filament 8801 has a first top electrode 8803 and a bottom electrode 8804. The bulb head 8810 defines a container space 8812 with the bulb shell 8809 for enclosing the multiple LED filaments 8801, 8802.

The central column 8807 includes a support 8806 and a column part 8805. The bracket 8808 is fixed to a top end 8813 of the column part 8805 and extending outwardly. A bottom end 8814 of the column part 8805 is fixed to the support 8806. The top electrodes 8803 of the multiple LED filaments 8801 are fixed to the bracket 8808 to keep a tilt angle with respect to a longitudinal direction of the central column 8807.

The multiple supporting wires 8811 are respectively connected the bottom electrodes 8804 of the multiple LED filaments 8801 to the support 8806 of the central column 8807.

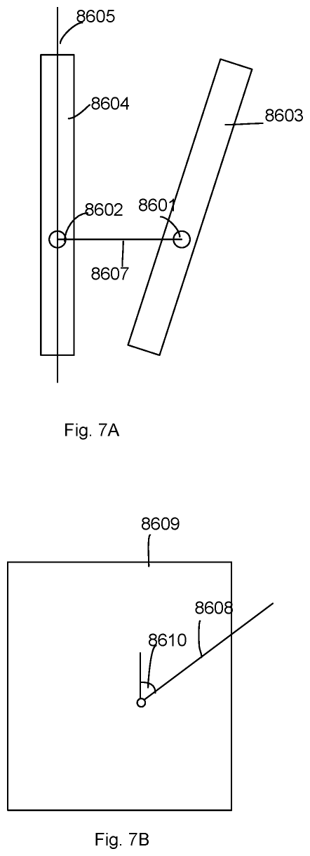

In FIG. 7A and FIG. 7B, there is a first closet point 8601 of the LED filament 8603 with a closest distance from the LED filament 8603 to a second closest point 8602 of the central column 8604, a first line 8607 defined by the first closest point 8601 and the second closest point 8602 and the longitudinal direction 8605 of the central column 8604 form a first plane 8609 illustrated in FIG. 7B. The tilt angle 8610 measured between a longitudinal direction of the LED filament 8608 and the first plane 8609.

In some embodiments, the tilt angle is between 10 degrees to 60 degrees. In some embodiments, the closest point of the LED filament is closer to the bottom electrode of the LED filament than to the top electrode of the LED filament.

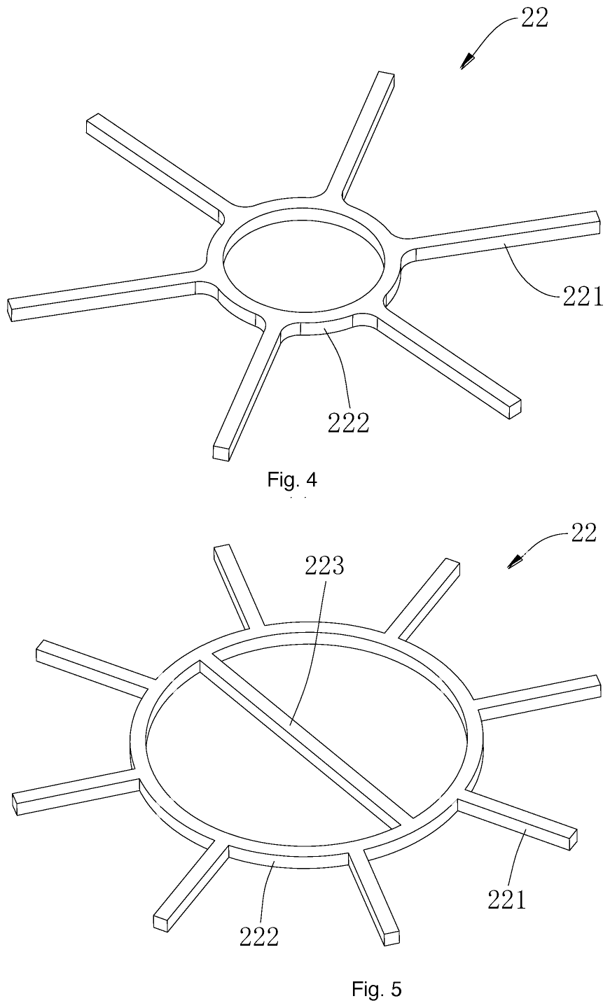

In some embodiments, the bracket has multiple extending wires respectively for connecting to the top ends of the multiple LED filaments, as illustrated in FIG. 4 and FIG. 5.

In some embodiments, the bracket has a support ring, the extending wires are extended from the support ring, like the drawings of FIG. 4 and FIG. 5.

In some embodiments, there is a structure enhancing piece inside the support ring to enhance structural strengthens of the support ring.

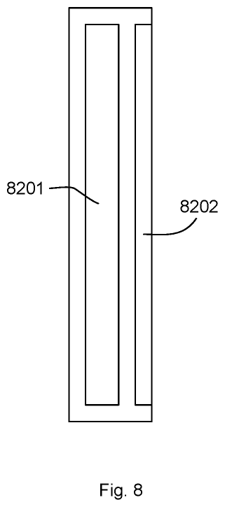

In FIG. 8, there are a first set of LED chips 8201 and a second set of LED chips 8202, the first set of LED chips 8201 emitting light outwardly with respect to the light bulb and the second set of LED chips 8202 emitting light toward dark sections of an adjacent LED filament. Usually, each LED filament is mounted with multiple LED chips which has main emitting angle of 120 degrees. When the LED filaments are disposed vertically, there are some dark areas not being fully illuminated. In the embodiment, the multiple LED filaments are arranged with tilt angles for emitting a portion of light to dark area of an adjacent LED filament. In this example, the second set of LED chip 8202 are specifically disposed for covering the dark area of adjacent LED filament while the first set of LED chips 8201 emit light normally outwardly passing out the light bulb.

In FIG. 6, the light bulb may also include a driver 8822 for controlling a luminance level ratio between the first set of LED chips and the second set of LED chips as illustrated in FIG. 8 to keep an even overall light pattern of the light bulb.

In FIG. 6, there are multiple lens 8824, 8825 arranged on the bulb shell.

In some embodiments, the multiple lens has prism effect for diving a white light to multiple color beams.

In some embodiments, the bracket is made of metal material.

In some embodiments, the column part includes two vertical levers.

In some embodiments, the support of the central column is made of glass and has a sealed gas hole for installing heat dissipation gas into the container space.

In some embodiments, the heat dissipation gas in the container space contains oxygen more than 1% ratio of all heat dissipation gas.

In FIG. 7, the multiple supporting wires 8811, 8829 are respectively connected to different isolated heat sinks 8821, 8823, which may be metal pieces isolated with less heat conductive or heat isolation material. Such design prevents heat propagation.

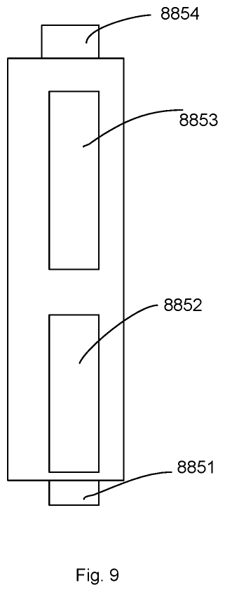

In FIG. 9, there are a first set of LED chips 8853 and a second set of LED Chips 8852 on the LED filament, the first set of LED chips 8853 are mounted closer to the top electrode 8854 of the LED filament and the second set of LED chips 8852 are mounted closer to the bottom electrode 8851 of the LED filament, the first set of LED chips 8853 emit lights with lower color temperature than the second set of LED chips 8852.

In some embodiments, the light bulb may also include a driver for controlling luminance levels of the multiple LED filaments to vary separately with a predetermined pattern along a time period to simulate a flame effect.

In some embodiments, a color temperature of the LED filament also varies when simulating the flame effect.

In some embodiments, the supporting wires and the bracket are deformed when installing into the bulb shell and recovers shapes after being placed into the bulb shell.

A filament bulb includes a bulb head, a bulb shell and multiple light source components. The bulb shell is disposed on the bulb head.

The light source components include a central glass column, a Nickel wire and multiple LED (Light Emitting Diode) light filaments. The central glass column is extended a bulb. The Nickel wire is led out by the central glass column. The multiple LED light filaments are connected to the Nickel wire.

However, the features of the LED light filaments create a light pattern with dark and white areas in a circumferential direction.

The aim of a lighting apparatus is to provide a wide angle of a filament bulb for luminescence. The lighting apparatus solves a light and dark patterns problem in the technique of nowadays.

In some embodiments, a technical program of the lighting apparatus is to provide a wide angle of the filament bulb for luminescence.

The filament bulb includes a bulb head, a bulb and multiple light source components. The bulb is disposed on the bulb head. The light source components are used for luminescence.

The light source components are connected to the bulb head. The light source components are extended the bulb.

The light source components include a central column, a bracket, and multiple LED light filaments. The central column is disposed on the bulb head. The bracket is disposed on the central column.

One side of the LED light filament is fixed on the bracket while the other side is connected to a supporting wire.

The supporting wire is fixed on the central column.

A circumferential direction of the central column is surrounded by multiple LED light filaments.

With respect to a longitudinal direction of the central column, the longitudinal direction of the LED light filament is on a tilt.

The LED light filament and a central axis of the central column are based on a different line and a different plane.

Further, the central axis of the central column is surrounded by the LED light filaments. The LED light filaments are disposed and formed in concentric arrays.

Further, a longitudinal direction of each LED light filament has a tilt angle between 10 to 60 degrees with respect to the longitudinal direction of the central column.

Further, a longitudinal direction of each LED light filament has a tilt angle between 15 to 45 degrees with respect to the longitudinal direction of the central column.

Further, the central column includes a support and at least one lever. The support is connected to the bulb head. The lever is extended out from one side of the support. A bracket is connected to the lever. A supporting wire is connected to the support.

Further, the lever and the bracket are both made of metal or hard material. Further, the support includes a trumpet segment and a support segment. A narrow end of the trumpet segment is connected to the support segment and the bulb. The lever is fixed on the support segment.

Further, an exhaust tube is disposed in the support segment. A gas hole is disposed on the support segment. The gas hole is connected to the exhaust tube.

Further, the bracket includes multiple extending levers. The extending levers are disposed on the central column. The extending levers and the LED light filaments are connected on one side.

Further, the bracket includes multiple support rings. The support rings are used for supporting the extending lever. The support ring is disposed on the lever. The extending lever is extended out from the support ring.

An advantage of the lighting apparatus is providing the wide angle of luminescence. The advantage is formed by multiple LED light filaments. The central column is surrounded by multiple LED light filaments.

With respect to a longitudinal direction of the central column, the LED light filament is disposed on the tilt.

The LED light filament and a central axis of the central column are based on the different planes.

With respect to the circumferential direction of the LED light filament, the LED light filament is on the tilt. The LED light filament makes a fanning section of light, and thus homogenizes the light in the wide angle of the filament bulb.

The lighting apparatus solves the light and dark patterns problem while achieving the 360 degrees wide angle of luminescence.

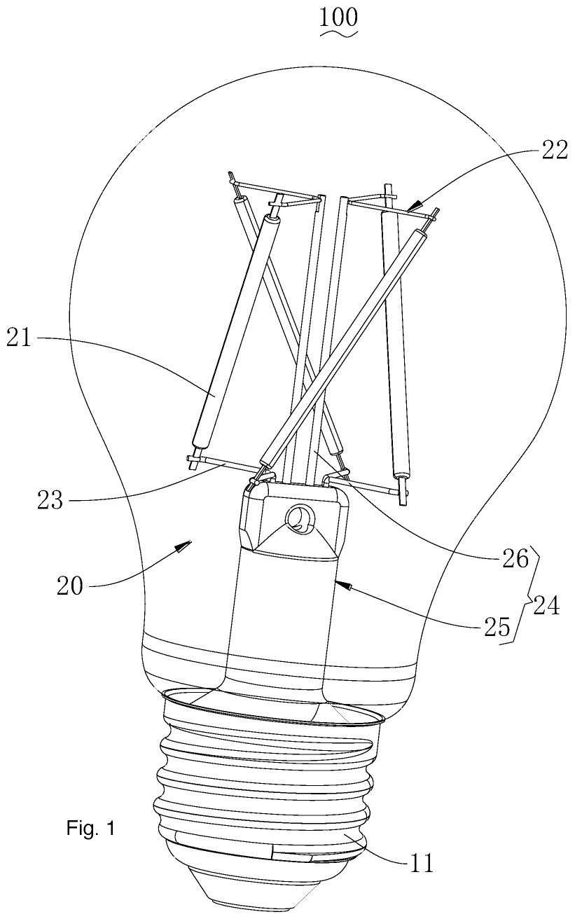

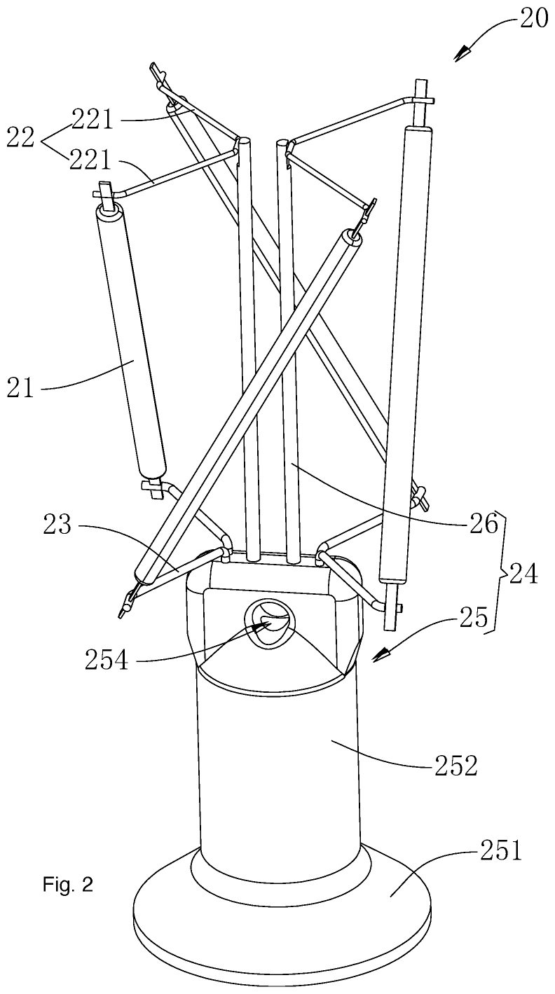

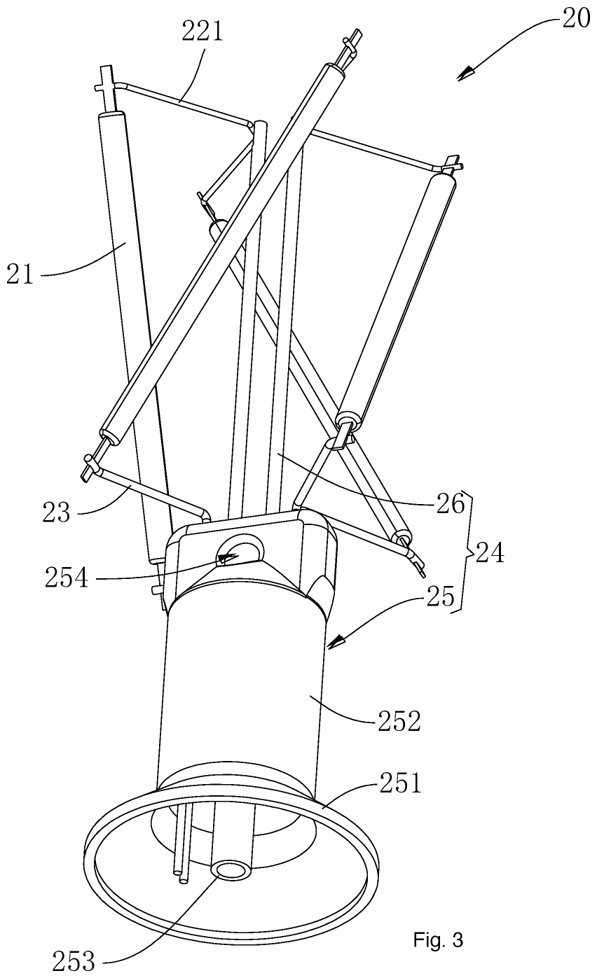

Please refer to FIG. 1 to FIG. 3. FIG. 1 to FIG. 3 provide a description of a filament bulb 100.

The filament bulb 100 includes a bulb head, a bulb 12 and a light source component 20.

The light source component 20 is extended the bulb 12.

The light source component 20 is connected to the bulb head 11 electrically.

The bulb head 11 is disposed on an exterior lamp holder in order to connect to an outer electric source.

The bulb 12 is disposed on the bulb head 11. The bulb 12 is used for protecting and adjusting the light source component 20. The bulb 12 also makes the light more even.

The light source component 20 includes a central column 24, a bracket 22 and multiple light filaments 21.

The central column 24 is disposed on the bulb head 11. The bulb head 11 is used for supporting the central column 24.

The bracket 22 is disposed on the central column 24.

One side of each light filament 21 is fixed to the bracket 22. The other side of each light filament 21 is connected to a supporting wire 23.

The supporting wire 23 is fixed on the central column 24 . The supporting wire 23 is supported the bracket 22 through the central column 24.

The supporting wire 23 supports and fixes each LED light filament 21. Multiple LED light filaments 21 are disposed around a circumferential direction of the central column 24. The LED light filaments 21 achieve the wide angle of luminescence.

With respect to a longitudinal direction of the central column, the longitudinal direction of the LED light filament is on the tilt.

Each LED light filament 21 and the central axis of the central column 24 are based on a different plane.

Each LED light filament 21 makes a fanning section of light.

The multiple LED light filaments 21 make an overlap lighting section in order to avoid some light and dark patterns.

The lighting apparatus is the filament bulb 100.

The lighting apparatus has multiple LED light filaments 21. The central column 24 is surrounded by the LED light filaments 21.

With respect to the longitudinal direction of the central column, the LED light filament is disposed with a tilt angle.

Each LED light filament 21 and the central axis of the central column 24 are based on the different planes.

Each LED light filament 21 makes a fanning section of light. With respect to the circumferential direction of the light source components 20, the fanning section of light is on a tilt. The fanning section of the light is homogenized in the wide angle of the filament bulb 100.

The LED light filaments 21 avoid the light and dark patterns. The LED light filaments 21 achieve the 360 degrees wide angle of luminescence.

In some examples, each LED light filament 21 and the central axis of the central column 24 are disposed on two parallel planes.

In some examples, a nearest dot between the LED light filament 21 and the central axis of the central column 24 forms the plane. With respect to the plane, the LED light filament 21 is on the tilt.

Please refer to FIG. 1 to FIG. 3. The filament bulb 100 is an embodiment. Multiple LED light filaments 21 dispose and form the central axis of the central column 24 in concentric arrays. The LED light filaments 21 homogenize the light of the filament bulb 100. The LED light filaments 21 make a design easier.

Please refer to FIG. 1 to FIG. 3. The filament bulb 100 is an embodiment.

The longitudinal direction of each LED light filament has a tilt angle between 10 to 60 degrees with respect to the longitudinal direction of the central column.

A nearest dot between the LED light filament 21 and the central axis of the central column 24 forms the plane. With respect to the plane, the LED light filament 21 is on the tilt.

More LED light filaments 21 are used when the tilt angle of the LED light filament 21 is small. More volume of the wide angle filament bulb 100 are used when the tilt angle of the LED light filament 21 is big.

The longitudinal direction of each LED light filament has the tilt angle between 15 to 45 degrees with respect to the longitudinal direction of the central column.

The amount and the length of the LED light filament 21 are used for a rational placement. The placement is used for assuring the equal luminescence .

Please refer to FIG. 1 to FIG. 3. The filament bulb 100 is an embodiment.

The central column 24 includes a support 25 and at least one lever 26. The support 25 is connected to the bulb head 11. The lever 26 is extended from one side of the bulb head 11. The lever 26 is connected to a bracket 22. The supporting wire 23 is connected to the support 25.

The support 25 is used for connecting the bulb head 11. The lever 26 is used for reducing the weight and the volume of the bracket 22. The lever 26 is supported the bracket 22. In other examples, a longer central column 24 is also acceptable.

Please refer to FIG. 1 to FIG. 3. The filament bulb 100 is an embodiment. The lever 26 is made of metal. The metal lever is used for avoiding the risk of breaking.

Moreover, the metal lever is used for conducting and supplying electricity to the LED light filament 21.

In some examples, the lever 26 is made of hard material plastic, such as an Acrylic.

The lever 26 is made of hard material plastic. Thus, a conducting wire or a wire are used for providing electricity to the LED light filament 21.

The bracket 22 is made of metal or hard material. Thus, the bracket 22 is used for supporting the LED light filament 21.

The bracket 22 is made of metal. Thus, the metal bracket 22 is used for supplying electricity to the LED light filament 21. The bracket 22 is made of hard material. Thus, the wire is used for electrical connection.

In the example, the amount of the lever 26 is two. The two lever 26 are disposed in a gap.

The amount of the lever 26 is also acceptable for more or less than two.

Please refer to FIG. 1 to FIG. 3. The filament bulb 100 is an embodiment. The support 25 is made of earthenware or hard material in order to avoid the risk of breaking. In some examples, a production of the support 25 takes less time. The support 25 is made of glass. The glass support 25 is used for connecting a bulb 12. When the support 25 is made of earthenware or hard material while the bulb 12 is made of plastic or glass. The bulb 12 is used for connecting the support 25.

Please refer to FIG. 1 to FIG. 3. The filament bulb 100 is an embodiment. The support 25 includes a trumpet segment 251 and a support segment 252. A wide narrow end of the trumpet segment 251 is connected to the support segment 252. A diameter end of the trumpet 251 is connected to the bulb 12. The lever 26 is fixed on the support segment 252.

The trumpet segment 251 is used for connecting the support 25. The support 25 is used for connecting the bulb head 11 steadily. The support segment 252 is used for supporting the lever 26.

Moreover, with respect to the support 25, the lever 26 is on a tilt. The lever 26 supports the bracket 22 and adjusts the tilt angle of the LED light filament 21.

Please refer to the FIG. 1 to FIG. 3. The filament bulb 100 is an embodiment.

An exhaust tube 253 is disposed in the support segment 252. A gas hole 254 of the support segment 252 is connected to the exhaust tube 253. The gas hole 254 is used for exhaling the gas of the bulb 12. Moreover, some heat conductive airs are filled into the bulb 12 for heat dissipation.

The diameter end of the trumpet segment 251 is used for connecting the bulb 12 while processing. The exhaust tube 253 is disposed in the support segment 252. The exhaust tube 253 exhales the gas and fills the heat conductive airs into the bulb 12.

The exhaust tube is sealed in order to avoid an air leakage.

In other examples, the central column 24 is longer. Thus, the exhaust tube 253 is disposed in the central column 24 directly.

Moreover, the support segment 252 is a cellular structure. The exhaust 253 is disposed in the support segment 252.

The cellular structure is used for disposing a wire in the support segment 252. The cellular structure is connected electrically to the LED light filament.

In other examples, the support segment 252 is a cellular structure. The tube hole is the exhaust tube 253.

Please refer to FIG. 1 to FIG. 3. The filament bulb 100 is an embodiment.

The bracket 22 includes multiple extending levers 221. Each extending lever 221 is disposed on the central column 24.

The extending lever 221 is used for connecting and supporting the LED light filament 21. Specifically, in the example, each extending lever 221 is connected to the lever 26.

A length of each bracket 22 is bent in half. The bending makes the extending lever 221 into four pieces.

In other examples, the amount of the extending lever 221 is acceptable for more than two.

An end of each extending lever 221 is connected to the central column 24 directly. In other examples, the end of each extending lever 221 is used for disposing a supportive structure. The end of each extending lever 221 is used for connecting each extending lever 221.The end of each extending lever 221 is used for connecting the supportive structure and the central column 24. The supportive structure has multiple kinds of forms, such as a circular, a ring or a torus etc.

Please refer to FIG. 4. The filament bulb 100 is an embodiment. The bracket 22 also includes multiple support rings 222. The support rings 222 are used for supporting the extending lever 221. The support rings 222 are disposed on the lever 26. The extending lever 221 is extended from the support ring 222. The support ring 222 is disposed for supporting the extending lever 221 and connecting the central column 24. The extending lever 221 is connected and disposed to the central column 24.

Moreover, an one-piece forming is formed by the support ring 222 and each extending lever 221.

Moreover, in the example, the amount of the extending levers 221 is six. The extending levers 221 are equally disposed in the circumferential direction of the support ring 222.

In other example, the amount of the extending lever 221 does not have to be six.

Please refer to FIG. 5. The filament bulb 100 is an embodiment.

The circumferential direction of the supporting ring 222 is disposed with eight extending levers 221.

Moreover, a boost lever 223 is disposed in the supporting ring 222.The boost lever 223 is used for enhancing the strength of the supporting ring 222 and the bracket 22.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A light bulb comprising:
multiple LED filaments, each LED filament has a first top electrode and a bottom electrode;
a bulb shell;
a bulb head for defining a container space with the bulb shell for enclosing the multiple LED filaments;
a central column, comprising a support and a column part;
a bracket, wherein the bracket is fixed to a top end of the column part and extending outwardly, the bottom electrode of the column part is fixed to the support, the top electrodes of the multiple LED filaments are fixed to the bracket to keep a tilt angle with respect to a longitudinal direction of the central column; and
multiple supporting wires respectively connecting the bottom ends of the multiple LED filaments to the support of the central column.

2. The light bulb of claim 1, wherein there is a first closet point of the LED filament with a closest distance from the LED filament to a second closest point of the central column, a first line defined by the first closest point and the second closest point and the longitudinal direction of the central column form a first plane, the tilt angle measured between a longitudinal direction of the LED filament and the first plane.

3. The light bulb of claim 2, wherein the tilt angle is between 10 degrees to 60 degrees.

4. The light bulb of claim 3, wherein the closest point of the LED filament is closer to the bottom electrode of the LED filament than to the top electrode of the LED filament.

5. The light bulb of claim 1, wherein the bracket has multiple extending wires respectively for connecting to the top ends of the multiple LED filaments.

6. The light bulb of claim 5, wherein the bracket has a support ring, the extending wires are extended from the support ring.

7. The light bulb of claim 6, wherein there is a structure enhancing piece inside the support ring to enhance structural strengthens of the support ring.

8. The light bulb of claim 1, wherein there are a first set of LED chips and a second set of LED chips, the first set of LED chips emitting light outwardly with respect to the light bulb and the second set of LED chips emitting light toward dark sections of an adjacent LED filament.

9. The light bulb of claim 8, further comprising a driver for controlling a luminance level ratio between the first set of LED chips and the second set of LED chips to keep an even overall light pattern of the light bulb.

10. The light bulb of claim 1, wherein there are multiple lens arranged on the bulb shell.

11. The light bulb of claim 10, wherein the multiple lens has prism effect for diving a white light to multiple color beams.

12. The light bulb of claim 1, wherein the bracket is made of metal material.

13. The light bulb of claim 12, wherein the column part comprises two vertical levers.

14. The light bulb of claim 1, wherein the support of the central column is made of glass and has a sealed gas hole for installing heat dissipation gas into the container space.

15. The light bulb of claim 14, wherein the heat dissipation gas in the container space contains oxygen more than 1% ratio of all heat dissipation gas.

16. The light bulb of claim 1, wherein the multiple supporting wires are respectively connected to different isolated heat sinks.

17. The light bulb of claim 1, wherein there are a first set of LED chips and a second set of LED Chips on the LED filament, the first set of LED chips are mounted closer to the top electrode of the LED filament and the second set of LED chips are mounted closer to the bottom electrode of the LED filament, the first set of LED chips emit lights with lower color temperature than the second set of LED chips.

18. The light bulb of claim 1, further comprising a driver for controlling luminance levels of the multiple LED filaments to vary separately with a predetermined pattern along a time period to simulate a flame effect.

19. The light bulb of claim 18, wherein a color temperature of the LED filament also varies when simulating the flame effect.

20. The light bulb of claim 1, wherein the supporting wires and the bracket are deformed when installing into the bulb shell and recovers shapes after being placed into the bulb shell.
